(19) United States
(12) Patent Application Publication
(10) Pub. No.: US 2022/0256324 A1
(43) Pub. Date: Aug. 11, 2022

(54) GEOGRAPHICAL PUBLIC ALERTING AND DISTRESS CALL SOLUTION

(71) Applicant: Saudi Arabian Oil Company, Ohahran (SA)

(72) Inventors: Khalid A. Al Arfaj, Dammam (SA); Ali M. Al Nasir, Safwa (SA)

(21) Appl. No.: 17/173,876

(22) Filed: Feb. 11, 2021

(51) Int. Cl. H04W 4/90; H04W 4/02; H04W 4/06

(52) U.S. Cl. CPC H04W 4/90; H04W 4/06; H04W 4/02

(57) ABSTRACT

Systems and methods include a computer-implemented method for broadcasting messages for a threat in a geographical area. A report of a threat is received at an approval authority of a distributed threat reporting system. The report is generated using a reporting application and includes a geographical location of the threat and detailed threat information. A determination is made by the approval authority as to whether the threat is to be broadcast. In response to determining that the threat is to be broadcast, a broadcast region is identified by the approval authority. The broadcast region identifies users to be notified in a geographical area affected by the threat. A broadcast message is broadcast by the approval authority to a subset of users of the distributed threat reporting system. The subset of users includes users in the broadcast region.

### TECHNICAL FIELD

The present disclosure applies to a system that facilitates a communication protocol to report threats, process reports, and broadcast a warning or distress call to the public in an identified geographical area.

### BACKGROUND

In some life-threatening situations, people may be at risk of a nearby imminent threat without knowing about the threat and without an easy or direct way to be alerted to the situation. For example, when a patient of a highly-contagious transmittable virus wanders into a public place, people in that area may be subject to infection without being alerted to the patient's presence. Similarly, a terrorist or a criminal in a public place may intend to do harm to people. However, if people can't recognize or be notified of the threat, then no one will react, such as to take precautions. In many situations, people may not know about the threat surrounding them, because the threat is either invisible or unrecognizable. Another scenario may exist when someone needs to get help from others but cannot issue a distress call or communicate directly with nearby people. Examples include a person falling in a public restroom because of illness or some other reason, or someone trapped in a building and who needs help from anyone in the general vicinity, but is unable to call for help. The problem may be complicated by the nonexistence of easy technology that is capable of alerting people regarding surrounding dangers or get their help to respond to a distress call to help others.

### SUMMARY

The present disclosure describes techniques that can be used to provide a system for geographical public alerts and distress calls. In some implementations, a computer-implemented method includes the following. A report of a threat is received at an approval authority of a distributed threat reporting system. The report is generated using a reporting application and includes a geographical location of the threat and detailed threat information. A determination is made by the approval authority as to whether the threat is to be broadcast. In response to determining that the threat is to be broadcast, a broadcast region is identified by the approval authority. The broadcast region identifies users to be notified in a geographical area affected by the threat. A broadcast message is broadcast by the approval authority to a subset of users of the distributed threat reporting system. The subset of users includes users in the broadcast region.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. The techniques can be used to alert people to problems in an identified geographical area. This can help in improving security and safety and can save lives of people located in the identified geographical area. The techniques can be generalized to all communities and operational areas. The techniques can allow an approval authority to broadcast warning messages or generate help calls to respondents within the specific geographical area. The techniques can provide authorized entities with the capability to direct messages to respondents within the specific geographical area, such as to respond to a threat warning or to provide help to someone in distress. Features associated with geographic locations can be used to determine the locations by using, for example, telecom tower triangulation through subscribers, or through a dedicated application. A mobile application can be used by a reporting agency or reporting authority, for example, to report a threat situation or to make a distress call and send the report information including a mandatory geographical location. The application can support specific authorizations by approval authorities to receive the report, verify the report, and to authorize the broadcast of warnings to respondents within an approximate area near the report location. The subscribers to the application can receive the message through an application, while people without the application can still receive the broadcast through short message service (SMS) messages or automated telephone calls. The techniques can be facilitated using Global Positioning System (GPS) technologies built into most common smart phones. The techniques can also be facilitated using telecommunication technologies of triangulation which can provide an approximate location of mobile devices communicating through communication towers.

Techniques of the present disclosure provide improvements over conventional geographical information system (GIS)-based technologies involved in reporting and reflecting a threat or emergency location. For example, such conventional technologies do not include the functionality of broadcasting the warning or distress call to respondents in that specific geographical area after receiving approval from a dedicated approval authority. The techniques of the present disclosure address the challenge of broadcasting alerts by approval authorities to specific receivers based on their geographical location. The techniques of the present disclosure can establish the rule of an approval authority that is capable of broadcasting the alert message to people in a specific geographical location through telecom channels such as SMS or dedicated applications. Additionally, the techniques provide the capability of supporting reports with multimedia formats.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a diagram of a mobile device displaying an application for initially reporting a threat, according to some implementations of the present disclosure.

FIG. 2 is a diagram of a mobile device displaying an application used by an approval authority to approve a report, according to some implementations of the present disclosure.

FIG. 3 is a diagram of a mobile device displaying the application providing a screen for broadcasting an accepted report, according to some implementations of the present disclosure.

FIG. 4 is a diagram showing an example of a cloud-based system for handling public alerting and distress calls in a geographical area, according to some implementations of the present disclosure.

FIG. 5 is a flowchart of an example of a method for handling public alerting and distress calls in a geographical area, according to some implementations of the present disclosure.

FIG. 6 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques used to provide a system for geographical public alerts and distress calls. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

Techniques of the present disclosure can include a communication protocol supported by technology to report threats and assist in expediting the response for distress calls to people in an identified geographical area. Protocols that are used can include, for example, a three-tier application including a first tier to report the threat, a second tier to receive the report and authorize a broadcast of the report, and a third tier for the receivers of the broadcasted message in a specific geographical area.

With the advancement of communication and instant messaging and alerting mechanisms, along with the advancement of geographical information system (GIS) technology, the ability to locate and communicate with people in an identified geographical location is becoming easier. However, there is no solution in place to facilitate such warning systems or support the response to a distress call in that area. In this era, communication is easily facilitated electronically through Internet and telecom communication networks. The techniques of the present disclosure allow the user to report a threat in a specific geographical area. The resulting reported threat can be approved by an authority in the area. Upon approval, a warning or a distress call can be broadcasted to the portable devices or wearables of people in that geographical area.

The present disclosure can include a set of mobile applications. A first application can allow reporters or distress callers to open the first application and report the threat or to send the distress call. The application can be a wearable device that will continuously update the approval authority with the current location. Also, the report or the call can be conducted through a normal telephone call or a short message service (SMS) message. The approver authority will validate and verify the request and accordingly determine if there are people in the surrounding area of the threat. Accordingly, the alert or the distress call can be broadcasted to those people who have the application installed or those located in the area through Global Positioning System (GPS) technology, such as through triangulation techniques applied by telecommunication companies through mobile towers.

The techniques of the present disclosure can support the establishment of clear rules and guidelines for the approval authorities, for example, in order to decide on the legitimacy of the threat or the distress call. The authority can then anonymously broadcast the threat alert or the distress call to mobile subscribers and non-scribers for everyone in the target geographic area.

In some implementations, systems using the techniques of the present disclosure can be adopted by governments as security alerting systems or by authorized health organizations to direct bystanders to help people in specific areas before medical assistance arrives. Two use cases are presented representing two types of users:

In a first use case, the threat can be a threat to people in a specific geographical area. The users that are part of the first use case can include the following. A reporter of Type A, for example, can be someone who will report the presence of the threat. The reporter can be, for example, a normal bystander or a governmental authority such as a police officer or security personnel. In some cases, the reporter can use an application in their mobile device that will allow the reporter to report the threat location and provide a description of the threat.

The success of techniques of the present disclosure can depend on a trust factor of the reporter. As an example, the trust factor can be based on one or both of historical information about the reporter and a criticality of the report.

In some implementations, a computer-implemented, distributed threat reporting system can include the following. Applications can execute on mobile devices of registered users of the computer-implemented distributed threat reporting system. The applications can be configured to receive input from a registered user and generate a report of a threat at a geographical location. An approval authority can be configured to receive and process reports received from the applications and to send broadcasts to people in a broadcast region who are affected by the threat.

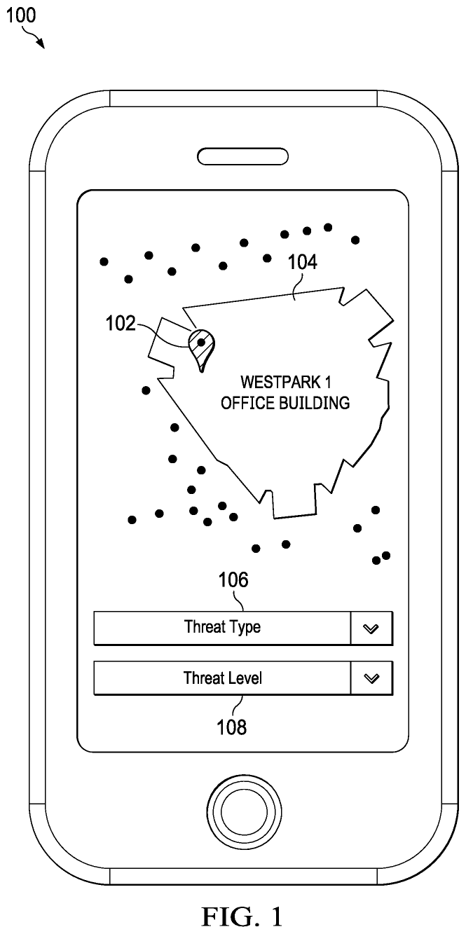

FIG. 1 is a diagram of a mobile device displaying an application 100 for initially reporting a threat, according to some implementations of the present disclosure. The reporting can be used to report a threat, where the report can be used to subsequently generate geographical public alerts and distress calls. The reporter can use an application (app), such as including a user interface, for placing a map pin 102 on a displayed map to identify the location of the threat. In some implementations, a location 104 can be identified on the map. In the same application, the reporter can select a threat type 106 (indicating the type of threat) and provide other relevant information before submitting the report. The other information can include a threat level 108, for example. The threat type 106 and threat level 108 can be definable in the app using drop-down lists, text fields, and other data entry techniques. The app 100 can also allow the user to input a description of the threat, such to describe features of one or more people who provide the threat (such as exhibiting violent or threatening behavior). In some implementations, the app 100 can provide an interface for the user to capture one or more of audio and video of the threat, which can be streamed to the approval authority for storage or broadcast. Dots and other symbols can be displayed in the application 100 to represent, for example, subscribers to the application and devices identified through the method of triangulation within the geographical area.

In another example, a reporter of Type B can be someone who is equipped with a mobile device or a wearable that is tracked by an approval authority, such as to send dynamic live reports to the approval authority based on pre-set conditions. This type of dynamic reporter can be, for example, a convicted criminal with a bracelet band, a patient with a specific disease, or someone who needs to be tracked for other reasons that necessitate alerts to be sent to other people in the vicinity of the reporter.

Threats can include any type of situation that warrants notification of people in an area. For example, a report can be generated for a pet or a young child wandering around unattended, an inanimate object such as a leaking plumbing fixture in an apartment building, or a hazard on a road or highway. The reporter of the threat does not need to be in the area at the time that the report is generated. For reporter may report the threat based on information received from a threat location, such as through an alarm or through video surveillance.

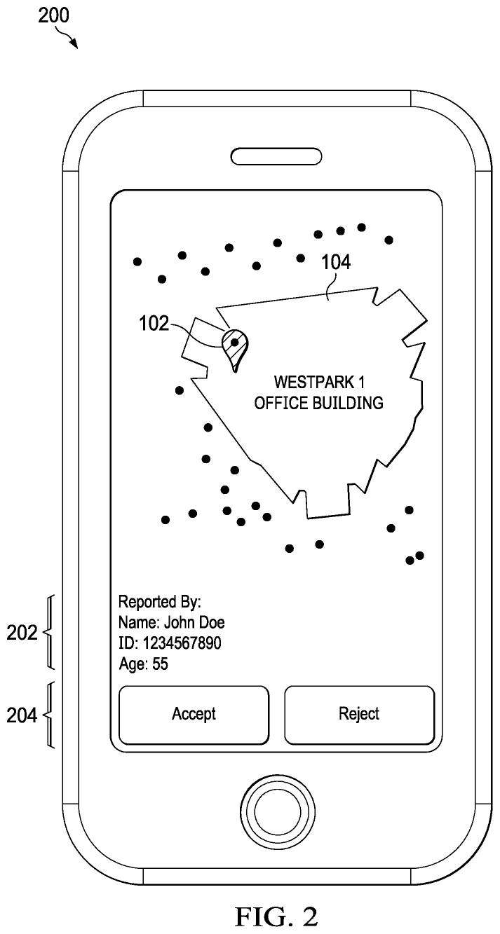

FIG. 2 is a diagram of a mobile device displaying an application 200 used by an approval authority to approve a report, according to some implementations of the present disclosure. The application 200 can display the map pin 102 and a label identifying a location 104 of the threat. The application 200 can display report information 202 including, for example, the name of the person who issued the report, the reporter's identification number, and demographic information (for example, age) of the person generating the report. The approval authority can have access to the application that will provide all detailed information about the reporter, a location of report, and a description of the situation from which the approval authority can make a decision whether or not and in what way to generate a broadcast. For example, the approval authority can approve or reject the report based on the detailed information. Controls 204, including an accept button and a reject button, can allow the person using the application 200, who is also the approval authority, to either approve the report or reject the report. The approval authority for a given report can be the authority (or part of a multi-level or hierarchical approval process) that will receive the report. The report may be for an incident that is located in the same geographical area or somewhere else, relative to the approval authority.

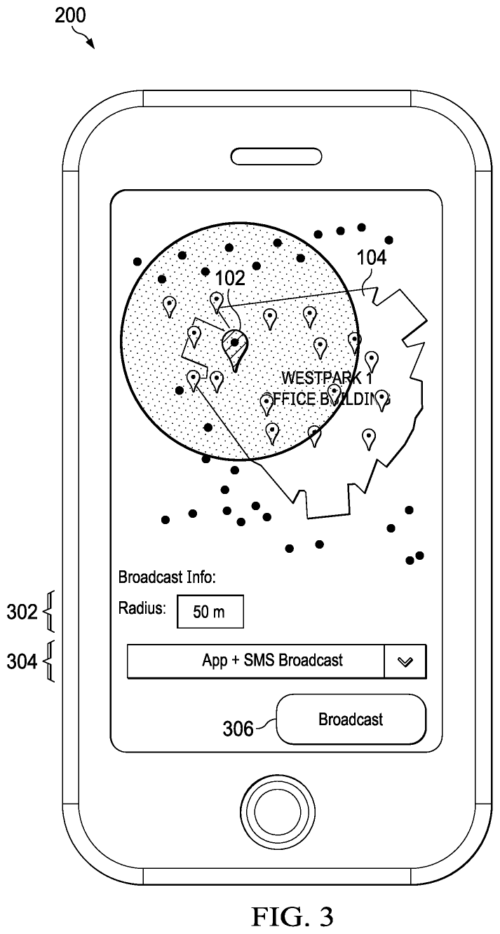

FIG. 3 is a diagram of a mobile device displaying the application 200 providing a screen for broadcasting an accepted report, according to some implementations of the present disclosure. For example, if the report presented in FIG. 2 is accepted, the display of FIG. 3 is a next step provided by the application 200. The approval authority can use the computer interface provided by the application 200, for example, to broadcast an alert to people in the geographical area. The application 200 can provide a radius field 302, for example, allowing the approval authority to identify a radius around the threat location for which to broadcast an alert. Using the radius field 302, the geographical radius of the respondents and the people to receive the alert and will broadcast the alert accordingly. In some implementations, for reports from type B reporters, for example, the application 200 can allow the approval authority to automatically broadcast to respondents in the reporter's area. The types of respondents to receive the report can be selected from a respondents control 304. The control can allow the user to send notifications in a combination of options including SMS, emails, and app notifications, which can be presented to the user as set of check boxes, This can be done using rules, for example, specifying types of reports or individual reporters, such as group names or categories and names of specific reporters. Respondents can include public users who need to be warned or alerted about the threat. Once the approval authority has selected the recipients of the broadcast message, a broadcast control 306 can be selected to send the broadcast.

In the case of a distress call, for example, someone may need help but may be unable to reach people in the area or unable to reach people in a timely manner. In this case, users of the system can include the following. A distress caller can be someone who will call for distress to get help. The same application 100 used for a threat alert can be used by the distress caller, or an SMS message can be sent to a specific number. Also, shortcuts in the application 100 can be configured to send a distress call immediately to approval authorities, such as by pressing a particular button on a mobile device, issuing a voice command, or upon the mobile device determining a condition (such as a sudden impact). In this case of a distress call, the approval authority can receive the call, review and validate the need for a distress call response, and act accordingly to broadcast the distress request to get help from people around the area. Respondents to the distress call can include public users who will receive the distress request and provide help to the distress caller.

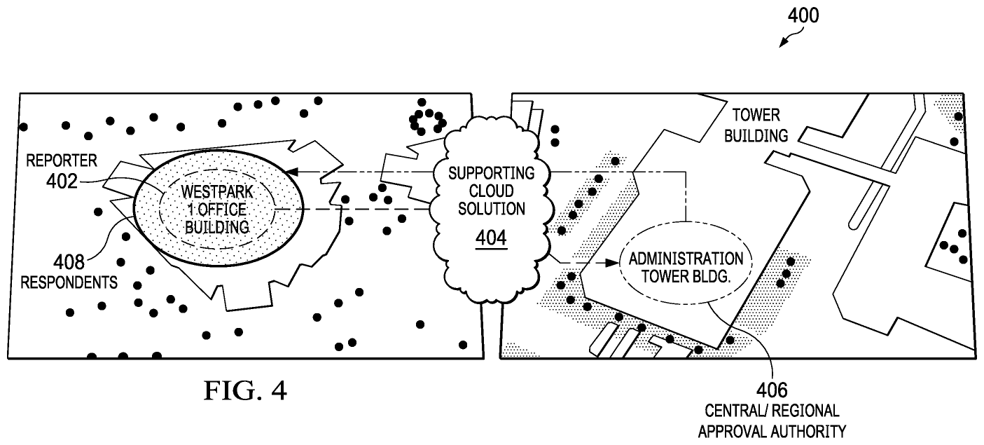

FIG. 4 is a diagram showing an example of a cloud-based system 400 for handling public alerting and distress calls in a geographical area, according to some implementations of the present disclosure. The system 400 can support the capabilities described with reference to FIGS. 1-3. Reports that are initiated by a reporter 402 and transmitted over a network 404 to a central/regional approval authority 406. Approved reports can be used to generate broadcast messages to respondents 408 within a radius distance centered on a location from which the report originated.

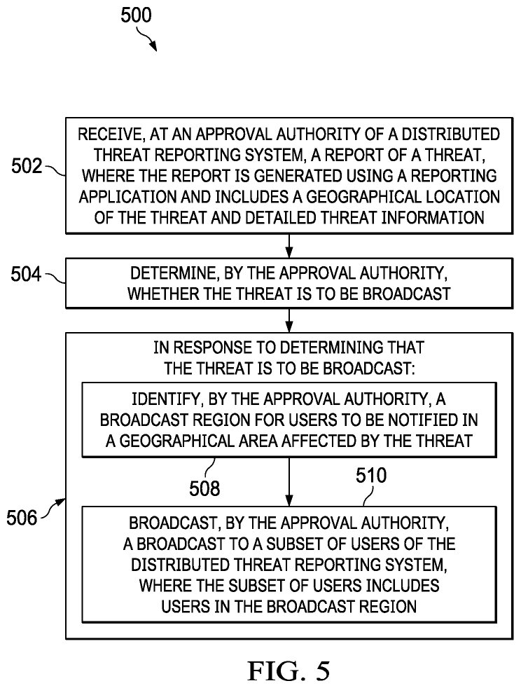

FIG. 5 is a flowchart of an example of a method 500 for handling public alerting and distress calls in a geographical area, according to some implementations of the present disclosure. For clarity of presentation, the description that follows generally describes method 500 in the context of the other figures in this description. However, it will be understood that method 500 can be performed, for example, by any suitable system, environment, software, and hardware, or a combination of systems, environments, software, and hardware, as appropriate. In some implementations, various steps of method 500 can be run in parallel, in combination, in loops, or in any order.

At 502, a report of a threat is received at an approval authority of a distributed threat reporting system. The report is generated using a reporting application and includes a geographical location of the threat and detailed threat information. As an example, the threat can be a threat of danger imposed on people in the geographical area. In another example, the threat of danger can apply to beings other than people, such as animals at a zoo or in a wilderness area. A reporter of the threat can be pre-registered with the distributed threat reporting system. As an example, the report can be received from a user (for example, a bystander or an official) using the application described with reference to FIG. 1. The official reporting of the threat can be, for example, a government official, a police officer, or security personnel. The detailed threat information can include a threat type, a threat level, and a threat description of the threat. The detailed information and a location marker of the geographical location of the threat can be displayed to an approval manager (for example, using the application 200) at the approving authority. From 502, method 500 proceeds to 504.

At 504, a determination is made by the approval authority as to whether the threat is to be broadcast. An identity of the reporter can be determined by the approval authority, including determining whether the reporter of the threat is a public bystander or an official. Information about the report and the reporter can be displayed in the application 200, for example, described with reference to FIGS. 2 and 3. A definition of the broadcast region to which to send the broadcast can be received from the approving authority, such as based on input from approval personal (for example, one or more approval managers). For example, the broadcast region can be an area defined within a user-specified radius of the geographical location.

In some implementations, determining whether the threat is to be broadcast can include receiving an approval to broadcast the broadcast from a hierarchy of approving parties. For example, for some types of threats, an approval process can rely on approvals by multiple levels of approval, such as hierarchical levels. From 504, method 500 proceeds to 506.

At 506, in response to determining that the threat is to be broadcast, a broadcast region is identified and a broadcast is sent. For example, at 508, a broadcast region is identified by the approval authority. The broadcast region identifies users to be notified in a geographical area affected by the threat. At 510, a broadcast is broadcast by the approval authority to a subset of users of the distributed threat reporting system. The subset of users includes users in the broadcast region. Broadcast recipients of the broadcast can be based on recipient locations in the geographical area. A distribution list that includes the broadcast recipients can be generated by the approving authority, such as by determining that geographic locations of the recipients are contained within the broadcast region. GPS capabilities can be used for determining the recipients' locations. After 510, method 500 can stop.

In some implementations, method 500 further includes registering users to use applications for reporting threats and for receiving broadcasts. Some users may elect to have only the reporting application, and some users may elect to have only an application that receives broadcasts (or allows broadcasts to be received on their mobile devices, such as by subscribing to a service).

In some implementations, the application 100 can be used to specify that the threat has passed, such as after aid or an emergency response has arrived at the threat location. In some implementations, notification of the threat that is received by the recipient can be delayed until after the recipient has entered the broadcast region, such as by automobile or on foot. In some implementations, recipients can be notified to avoid certain areas, such as containing the threat location or intersecting the broadcast region.

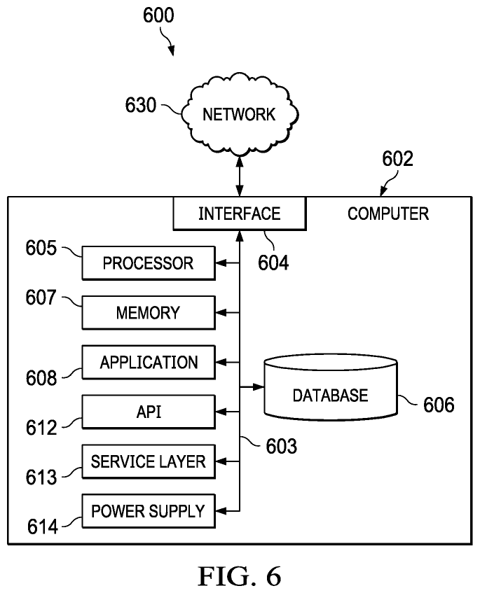

FIG. 6 is a block diagram of an example computer system 600 used to provide computational functionalities associated with described algorithms, methods, functions, processes, flows, and procedures described in the present disclosure, according to some implementations of the present disclosure. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a top level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both) over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format. While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the interface's hardware can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Described implementations of the subject matter can include one or more features, alone or in combination.

For example, in a first implementation, a computer-implemented method includes the following. A report of a threat is received at an approval authority of a distributed threat reporting system. The report is generated using a reporting application and includes a geographical location of the threat and detailed threat information. A determination is made by the approval authority as to whether the threat is to be broadcast. In response to determining that the threat is to be broadcast, a broadcast region is identified by the approval authority. The broadcast region identifies users to be notified in a geographical area affected by the threat. A broadcast message is broadcast by the approval authority to a subset of users of the distributed threat reporting system. The subset of users includes users in the broadcast region.

The foregoing and other described implementations can each, optionally, include one or more of the following features:

A first feature, combinable with any of the following features, where the threat is a threat of danger imposed on people in the geographical area, and wherein a reporter of the threat is pre-registered with the distributed threat reporting system.

A second feature, combinable with any of the previous or following features, the method further including determining, by the approval authority, an identity of the reporter, including determining whether the reporter of the threat is a public bystander or an official.

A third feature, combinable with any of the previous or following features, where the detailed threat information includes a threat type, a threat level, and a threat description of the threat, and wherein the detailed information and a location marker of the geographical location of the threat are displayed to an approval manager at the approving authority.

A fourth feature, combinable with any of the previous or following features, the method further including: receiving, using input of the approval manager of the approving authority, a definition of the broadcast region to which to broadcast the broadcast; identifying, by the approving authority, broadcast recipients of the broadcast based on recipient locations in the geographical area; and generating, by the approving authority, a distribution list that includes the broadcast recipients.

A fifth feature, combinable with any of the previous or following features, where the broadcast region is an area defined within a user-specified radius of the geographical location.

A sixth feature, combinable with any of the previous or following features, where determining whether the threat is to be broadcast includes receiving an approval to broadcast the broadcast from a hierarchy of approving parties.

In a second implementation, a non-transitory, computer-readable medium stores one or more instructions executable by a computer system to perform operations including the following. A report of a threat is received at an approval authority of a distributed threat reporting system. The report is generated using a reporting application and includes a geographical location of the threat and detailed threat information. A determination is made by the approval authority as to whether the threat is to be broadcast. In response to determining that the threat is to be broadcast, a broadcast region is identified by the approval authority. The broadcast region identifies users to be notified in a geographical area affected by the threat. A broadcast message is broadcast by the approval authority to a subset of users of the distributed threat reporting system. The subset of users includes users in the broadcast region.

The foregoing and other described implementations can each, optionally, include one or more of the following features:

A first feature, combinable with any of the following features, where the threat is a threat of danger imposed on people in the geographical area, and wherein a reporter of the threat is pre-registered with the distributed threat reporting system.

A second feature, combinable with any of the previous or following features, the operations further including determining, by the approval authority, an identity of the reporter, including determining whether the reporter of the threat is a public bystander or an official.

A third feature, combinable with any of the previous or following features, where the detailed threat information includes a threat type, a threat level, and a threat description of the threat, and wherein the detailed information and a location marker of the geographical location of the threat are displayed to an approval manager at the approving authority.

A fourth feature, combinable with any of the previous or following features, the operations further including: receiving, using input of the approval manager of the approving authority, a definition of the broadcast region to which to broadcast the broadcast; identifying, by the approving authority, broadcast recipients of the broadcast based on recipient locations in the geographical area; and generating, by the approving authority, a distribution list that includes the broadcast recipients.

A fifth feature, combinable with any of the previous or following features, where the broadcast region is an area defined within a user-specified radius of the geographical location.

A sixth feature, combinable with any of the previous or following features, where determining whether the threat is to be broadcast includes receiving an approval to broadcast the broadcast from a hierarchy of approving parties.

In a third implementation, a computer-implemented distributed threat reporting system includes: applications executing on mobile devices of registered users of the computer-implemented distributed threat reporting system, the applications configured to receive input from a registered user and generate a report of a threat at a geographical location; and an approval authority configured to receive and process reports received from the applications and to send broadcasts to people in a broadcast region who are affected by the threat. The computer-implemented system also includes one or more processors and a non-transitory computer-readable storage medium coupled to the one or more processors and storing programming instructions for execution by the one or more processors. The programming instructions instruct the one or more processors to perform operations including the following. A report of a threat is received at an approval authority of a distributed threat reporting system. The report is generated using a reporting application and includes a geographical location of the threat and detailed threat information. A determination is made by the approval authority as to whether the threat is to be broadcast. In response to determining that the threat is to be broadcast, a broadcast region is identified by the approval authority. The broadcast region identifies users to be notified in a geographical area affected by the threat. A broadcast message is broadcast by the approval authority to a subset of users of the distributed threat reporting system. The subset of users includes users in the broadcast region.

The foregoing and other described implementations can each, optionally, include one or more of the following features:

A first feature, combinable with any of the following features, where the threat is a threat of danger imposed on people in the geographical area, and wherein a reporter of the threat is pre-registered with the distributed threat reporting system.

A second feature, combinable with any of the previous or following features, the operations further including determining, by the approval authority, an identity of the reporter, including determining whether the reporter of the threat is a public bystander or an official.

A third feature, combinable with any of the previous or following features, where the detailed threat information includes a threat type, a threat level, and a threat description of the threat, and wherein the detailed information and a location marker of the geographical location of the threat are displayed to an approval manager at the approving authority.

A fourth feature, combinable with any of the previous or following features, the operations further including: receiving, using input of the approval manager of the approving authority, a definition of the broadcast region to which to broadcast the broadcast; identifying, by the approving authority, broadcast recipients of the broadcast based on recipient locations in the geographical area; and generating, by the approving authority, a distribution list that includes the broadcast recipients.

A fifth feature, combinable with any of the previous or following features, where the broadcast region is an area defined within a user-specified radius of the geographical location.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
receiving, at an approval authority of a distributed threat reporting system, a report of a threat, wherein the report is generated using a reporting application and includes a geographical location of the threat and detailed threat information;
determining, by the approval authority, whether the threat is to be broadcast; and
in response to determining that the threat is to be broadcast:
identifying, by the approval authority, a broadcast region for users to be notified in a geographical area affected by the threat; and
broadcasting, by the approval authority, a broadcast to a subset of users of the distributed threat reporting system, wherein the subset of users includes users in the broadcast region.

2. The computer-implemented method of claim 1, wherein the threat is a threat of danger imposed on people in the geographical area, and wherein a reporter of the threat is pre-registered with the distributed threat reporting system.

3. The computer-implemented method of claim 2, further comprising:
determining, by the approval authority, an identity of the reporter, including determining whether the reporter of the threat is a public bystander or an official.

4. The computer-implemented method of claim 1, wherein the detailed threat information includes a threat type, a threat level, and a threat description of the threat, and wherein the detailed information and a location marker of the geographical location of the threat are displayed to an approval manager at the approving authority.

5. The computer-implemented method of claim 4, further comprising:
receiving, using input of the approval manager of the approving authority, a definition of the broadcast region to which to broadcast the broadcast;
identifying, by the approving authority, broadcast recipients of the broadcast based on recipient locations in the geographical area; and
generating, by the approving authority, a distribution list that includes the broadcast recipients.

6. The computer-implemented method of claim 5, wherein the broadcast region is an area defined within a user-specified radius of the geographical location.

7. The computer-implemented method of claim 1, wherein determining whether the threat is to be broadcast includes receiving an approval to broadcast the broadcast from a hierarchy of approving parties.

8. A non-transitory, computer-readable medium storing one or more instructions executable by a computer system to perform operations comprising:
receiving, at an approval authority of a distributed threat reporting system, a report of a threat, wherein the report is generated using a reporting application and includes a geographical location of the threat and detailed threat information;
determining, by the approval authority, whether the threat is to be broadcast; and
in response to determining that the threat is to be broadcast:
identifying, by the approval authority, a broadcast region for users to be notified in a geographical area affected by the threat; and
broadcasting, by the approval authority, a broadcast to a subset of users of the distributed threat reporting system, wherein the subset of users includes users in the broadcast region.

9. The non-transitory, computer-readable medium of claim 8, wherein the threat is a threat of danger imposed on people in the geographical area, and wherein a reporter of the threat is pre-registered with the distributed threat reporting system.

10. The non-transitory, computer-readable medium of claim 9, the operations further comprising:
determining, by the approval authority, an identity of the reporter, including determining whether the reporter of the threat is a public bystander or an official.

11. The non-transitory, computer-readable medium of claim 8, wherein the detailed threat information includes a threat type, a threat level, and a threat description of the threat, and wherein the detailed information and a location marker of the geographical location of the threat are displayed to an approval manager at the approving authority.

12. The non-transitory, computer-readable medium of claim 11, the operations further comprising:
receiving, using input of the approval manager of the approving authority, a definition of the broadcast region to which to broadcast the broadcast;
identifying, by the approving authority, broadcast recipients of the broadcast based on recipient locations in the geographical area; and
generating, by the approving authority, a distribution list that includes the broadcast recipients.

13. The non-transitory, computer-readable medium of claim 12, wherein the broadcast region is an area defined within a user-specified radius of the geographical location.

14. The non-transitory, computer-readable medium of claim 8, wherein determining whether the threat is to be broadcast includes receiving an approval to broadcast the broadcast from a hierarchy of approving parties.

15. A computer-implemented distributed threat reporting system, comprising:
applications executing on mobile devices of registered users of the computer-implemented distributed threat reporting system, the applications configured to receive input from a registered user and generate a report of a threat at a geographical location;
an approval authority configured to receive and process reports received from the applications and to send broadcasts to people in a broadcast region who are affected by the threat;
one or more processors; and
a non-transitory computer-readable storage medium coupled to the one or more processors and storing programming instructions for execution by the one or more processors, the programming instructions instructing the one or more processors to perform operations comprising:
receiving, at the approval authority of the distributed threat reporting system, a report of the threat, wherein the report is generated using a reporting application and includes the geographical location of the threat and detailed threat information;
determining, by the approval authority, whether the threat is to be broadcast; and
in response to determining that the threat is to be broadcast:
identifying, by the approval authority, the broadcast region for users to be notified in a geographical area affected by the threat; and
broadcasting, by the approval authority, a broadcast to a subset of users of the distributed threat reporting system, wherein the subset of users includes users in the broadcast region.

16. The computer-implemented distributed threat reporting system of claim 15, wherein the threat is a threat of danger imposed on people in the geographical area, and wherein a reporter of the threat is pre-registered with the distributed threat reporting system.

17. The computer-implemented distributed threat reporting system of claim 16, the operations further comprising:
determining, by the approval authority, an identity of the reporter, including determining whether the reporter of the threat is a public bystander or an official.

18. The computer-implemented distributed threat reporting system of claim 15, wherein the detailed threat information includes a threat type, a threat level, and a threat description of the threat, and wherein the detailed information and a location marker of the geographical location of the threat are displayed to an approval manager at the approving authority.

19. The computer-implemented distributed threat reporting system of claim 18, the operations further comprising:
receiving, using input of the approval manager of the approving authority, a definition of the broadcast region to which to broadcast the broadcast;
identifying, by the approving authority, broadcast recipients of the broadcast based on recipient locations in the geographical area; and
generating, by the approving authority, a distribution list that includes the broadcast recipients.

20. The computer-implemented distributed threat reporting system of claim 19, wherein the broadcast region is an area defined within a user-specified radius of the geographical location.
